(19) United States
(12) Patent Application Publication
(10) Pub. No.: US 2003/0018633 A1
(43) Pub. Date: Jan. 23, 2003

(54) Robust reference interval estimator

(75) Inventor: Paul S. Horn, Cincinnati, OH (US)

Correspondence Address: David E. Franklin, Wood, Herron & Evans, L.L.P., 2700 Carew Tower, 441 Vine Street, Cincinnati, OH, 45020-2917, US

(73) Assignee: University of Cincinnati

(21) Appl. No.: 09/822,369

(22) Filed: Mar. 30, 2001

(51) Int. Cl. G06F 7/00

(52) U.S. Cl. 707/4

(57) ABSTRACT

A robust Reference Interval estimator determines a Reference Interval from a data sample as small as 20 skewed data samples, even in the presence of outlier samples. This ability avoids expensive tests to increase the data sample or allows calculation of a Reference Interval when only a small cohort for sampling is available. First, a set of data samples are power transformed to remove a non-Gaussian skew to the set. Then, the Tukey approach is used to identify an outlier cutoff and the set of data samples are truncated to remove outlier data samples that are beyond the outlier cutoff. The truncated set of data samples are then used to compute the Reference Interval. The truncated sets of data samples are then also power transformed to compute the Reference Interval.

### TECHNICAL FIELD

The present invention generally relates to a statistical system for computing reference intervals for skewed data samples containing outliers.

### BACKGROUND OF THE INVENTION

The Reference Interval is the most widely used medical decision-making tool. It is central to the determination as to whether or not an individual is healthy. Simply put, a Reference Interval for a particular analyte (e.g., creatinine) provides a range of acceptable values for healthy cohorts, i.e., individuals of the same race, gender, age, etc. For example, if a patient's creatinine concentration, as determined by a laboratory, lies outside of the Reference Interval, the value is flagged, and the patient is designated for possible further examination. The problem here is two-fold: first, the Reference Interval is determined from the samples available to the particular laboratory. These samples may, or may not, be comprised of all healthy individuals. Second, the size of the sample may not be adequate to estimate the endpoints of the Reference Interval to any reasonable degree of precision. The end result is increased number of incorrect decisions leading to increased cost and suffering. The problems associated with attempts to address these shortfalls by nonparametric or parametric approaches are discussed in “A robust approach to reference interval estimation and evaluation,” by Paul S. Horn, A. J. Pesce, and B. E. Copeland, Clinical Chemistry, 1998, 44: 622-631.

The concept of a Reference Interval in medicine is based on determining a set of values within which some percentage, 95% for example, of the values of a particular analyte in a healthy population would fall. This interval is then used for medical decision making. Recommendations as to how to obtain such Reference Intervals have focused on the types of statistics best used to calculate such a Reference Interval. These parameters then determine the number of individual specimens required to describe the Reference Interval with a high degree of confidence. Laboratories are mandated by the College of American Pathologists and the Joint Commission for the Accreditation of Health Organizations, and Health Care Finance Administration, to determine Reference Intervals for the populations they serve.

Currently, the National Committee for Clinical Laboratory Standards (NCCLS) has published guidelines on how to determine Reference Intervals, specifically, “How to define and determine reference intervals in the clinical laboratory; approved guideline,” by E. A. Sasse, K. J. Aziz, E. K. Harris, S. Krishnamurthy, H. T. Lee, Jr., A. Rutland, and B. Seamonds, NCCLS document C28-A, 1995, 15, Number 4. The NCCLS recommends that an interval based on nonparametric statistics be used in Reference Interval determination. Such an interval is simple in form, depending only on the ordered data points (order statistics) from the observed sample. For example, to compute a 95% Reference Interval, the 2.5% and 97.5% points of the distribution of the population of interest must be estimated. Here, P=2.5 and the minimum required number of observations is n=(100/P −1)=39. In this case, n=39; the 95% Reference Interval would consist of the minimum value (first order statistic and the maximum value (39th order statistic). As a further example, if n=99, then the nonparametric Reference Interval would consist of 0.025*(99+1)=2.5 order statistics from above and below, i.e., the average of the 2nd and 3rd order statistics for 2.5% endpoint and the average of the 98th and 99th order statistics for the 97.5% endpoint.

The NCCLS points out, however, that it is not desirable to rely on the extremes of the sample, since outliers, if they exist, will occur in that part of the sample. An outlier is an observation in a data set which is far removed in value from the others in the data set. It is an unusually large or an unusually small value compared to the others. An outlier might be the result of an error in measurement, in which case it will distort the interpretation of the data, having undue influence on many summary statistics, for example, the mean. If an outlier is a genuine result, it is important because it might indicate an extreme of behavior of the process under study. In particular, often with regard to determination of a medical Reference Interval, outliers represent an unhealthy individual.

Thus, the NCCLS recommends that nonparametric Reference Intervals be used and that the sample size, n, consist of at least 120. For n=120, the 95% Reference Interval would consist of the 3rd and 118th order statistics. The NCCLS notes that, when the sample size is at least 120, the determination of 90% confidence intervals for each of endpoints of the Reference Interval is possible. These confidence intervals provide an estimate of the precision of the endpoints of the Reference Interval. For n=120, the 90% confidence interval for the lower endpoint of the 95% Reference Interval consists of the 1st and 7th order statistics, while that of the upper endpoint consists of the 114th and 120th order statistics.

The NCCLS does recognize that obtaining sample sizes of 120 for a particular category of individuals may not be feasible. In such cases, the NCCLS still maintains that nonparametric methods be used with the understanding that the percentage level of the Reference Interval may need to be relaxed (and that 90% confidence intervals may need to be omitted). Thus, if only 39 individuals were available, then the 95% Reference Interval would consist of the minimum and maximum values, as before. If n=9, then the minimum and maximum values would define a 90% Reference Interval.

The NCCLS recognizes that outliers in the data are a real possibility. However, the recommendation is that, unless it is known that such points are aberrant for known reasons (e.g., a mistake in the analysis), attempts should be made to retain the values instead of deleting them. Nevertheless, the NCCLS recommends that Dixon's outlier range statistic be used, especially for Reference Intervals determined by the nonparametric procedure. Dixon's test is as follows: let R equal the range of the values (maximum-minimum) and let D equal the absolute difference between the most extreme (large or small) value and the next most value (large or small). If the ratio D/R exceeds 1/3, then the extreme value in question is deleted. The NCCLS points out that, if there are two or three outliers on the same side of the sample, this rule may fail due to masking, i.e., the less extreme outliers mask the aberrance of the most extreme (and vice versa). The recommendation is to test the least extreme outlier as if it were the only outlier. If the D/R test rejects the least extreme outlier, then the more extreme outliers are rejected as well. Unfortunately, the NCCLS never says how these outlier candidates are determined.

The International Federation of Clinical Chemistry (IFCC) also recommends use of the nonparametric approach to Reference Interval Estimation: Statistical treatment of collected reference values. Determination of reference limits, IFCC, approved recommendation (1987) on the theory of reference values, Part 5, Journal of Clinical Chemistry and Clinical Biochemistry 1987; 25: 645-56. The IFCC does not recommend use of outlier detection schemes because of their possible shortcomings, as previously described. The IFCC recommends omission of values only if a cause for the aberrant value is determined. Though the IFCC recommends the nonparametric approach, it recognizes that many prefer a parametric approach and thus this method is described in the IFCC document.

The traditional parametric approach to the problem of estimating Reference Intervals, as described by the IFCC, is based on the Gaussian or Normal distribution (the traditional bell-curve). If the data on hand consists of a random sample from a Gaussian distribution, then the (1−α)100% Reference Interval is defined as:

\overline{x}±Z₁−α/2·Sₓ, where, \overline{x}=Σxₗ/N, the sample mean, Sₓ={Σ(x₁−\overline{x})²/(N−1)}^{½}

the sample standard deviation, N is the sample size, and Z_{1-α/2} the appropriate standard Gaussian deviate (e.g., if α=0.05 then Z_{1-α/2}=Z_{0.975}=1.96). Since this is only valid for Gaussian data and since most analytical data are non-Gaussian, a transformation of the original data (e.g., apply the natural logarithm, ln, to all of the observations) is used so that the above Reference Interval is valid. Once this is achieved, it is only required to back-transform to the original units (e.g., if the natural logarithm “ln” was the transform, the back-transform applied to the resulting Gaussian-theory Reference Interval endpoints would be the exponential function, exp). The IFCC recommends, then arises as to the best statistical method to calculate the Reference Interval when limited numbers of observations are available.

Robust statistical methods have been developed over the last 35 years to deal with the problem of deviations of statistical models from ideal conditions. Specifically, traditional Normal theory methods are optimal if the underlying distribution of the data is Normal. However, if the underlying distribution is not Normal, then methods based on Normal theory tend to be very inefficient. Inefficiency here means not extracting as much information as possible from the data. A major source of this inefficiency is the influence of outlier(s) on the sample mean and standard deviation. Nonparametric methods do not make assumptions as to the specific form of the underlying distribution of the data. Nonparametric methods are reasonably efficient for very large samples, but are less so otherwise; in particular, in cases where the Reference Interval is calculated from a small number of samples, say 20. In these cases, the nonparametric statistic may use the extreme values of the sample, thus becoming susceptible to influence by outliers. In other words, the tail will wag the dog.

Robust methods, on the other hand, are sturdier in that they resist outlier influence by “downweighting” values that are further from the center of the sample. A simple example would use a 10% trimmed mean instead of the sample mean. In this case, the lower and upper 10% of the data would get weight zero, the middle 80% would then be averaged. This simple estimator would resist up to 10% outliers on each side. Simultaneously, robust methods are quite efficient, even in the ideal case of Normal data. Thus, although robust methods are not optimal for the ideal case, they are efficient in the case of calculating Reference Intervals. This statistical efficiency, i.e., getting the most information from the data while resisting outliers, translates into more efficient use of healthcare data, thus reducing costs and inaccuracies in health status classification. It is important to stress that the proposed robust methods allow for the determination of Reference Intervals when large samples are not available, as required by traditional nonparametric methods. Such cases of small samples occur when the underlying population of interest is, for example, very young or very old, or when the individual measurements are expensive to obtain and/or very invasive by nature. For example, it is not practical in terms of cost to obtain, for instance, a sample of 120 healthy males aged 80-89. Thus, robust methods will be more cost-effective.

Therefore, a significant need exists for a Reference Interval estimator that will provide a reliable Reference Interval based on a small sample set.

### SUMMARY OF THE INVENTION

The purpose of this invention is to efficiently calculate Reference Intervals from data which may contain outliers. The novelty of the concept is that it deals with the possibility of an inherently noisy population as well as the possibility that outliers may exist in the sample simultaneously. This invention will be of great usefulness because a major problem confronting the delivery of health care is the inefficient use of available resources. Hundreds of millions of clinical laboratory tests are performed each year with the purpose of diagnosis and monitoring of health. Analyte Reference Intervals are used as guides to the physician. There is a need for statistical methods that are more efficient. This invention uses robust estimators and computationally intensive techniques and is able to improve the Reference Interval for each analyte so that there are fewer incorrectly categorized patients. Even with a data set of healthy individuals, the laboratory may not have a sample size large enough for the use of traditional nonparametric Reference Interval estimation. Using this invention, it is now possible to derive meaningful Reference Intervals for samples consisting of as few as 20 individuals. It is important to stress that the use of this invention extends beyond clinical laboratory testing and into every area of health care where the determination of healthy and unhealthy individuals must be established.

The main point of this application is that Reference Intervals are too wide as a result of small samples and/or contamination by unhealthy individuals. By using robust methods, in conjunction with robust outlier detection techniques, this invention is able to circumvent these problems, making better use of the available data, and thus providing more efficient estimates of the endpoints of the Reference Interval. This will provide a great cost-savings to society.

Consistent with one aspect of the invention, a set of data samples are power transformed to remove a non-Gaussian skew to the set. Then, the Tukey approach (Exploratory Data Analysis, by J. W. Tukey, Addison-Wesley, Reading: Mass.: 1977, p. 506) is used to identify an outlier cutoff and the set of data samples are truncated to remove outlier data samples that are beyond the outlier cutoff. A Reference Interval is computed from the truncated set of data samples. Then the truncated set of data samples are power transformed to remove the non-Gaussian skew. From the transformed, truncated set of data samples, another Reference Interval is computed, which includes reverse power transforming the Reference Interval to match the original set of data samples.

These and many other advantages of the present invention will be more clearly understood and appreciated by careful study of the following, more detailed description of illustrative embodiments of the present invention, taken in conjunction with the accompanying drawings.

### BRIEF DESCRIPTION OF THE DRAWINGS

The accompanying drawings, which are incorporated in and constitute a part of this specification, illustrate embodiments of the invention and, together with the general description of the invention given above and the detailed description of the embodiments given below, serve to explain the principles of the present invention.

FIG. 1 is a generalized block diagram showing a computer system for Reference Interval estimation in which the present invention may be implemented.

FIG. 2 is a flowchart of a sequence of operations performed by the Reference Interval Estimator of FIG. 1, consistent with aspects of the present invention.

### DETAILED DESCRIPTION OF THE DRAWINGS

The proposed robust Reference Interval procedure attempts to capture the nature of the distribution of healthy individuals based on a small data sample while simultaneously resisting the effects of outliers. Since the distribution of most sample sets of chemical analytes is skewed, even for healthy individuals, this poses a problem for outlier detection. It is often the case that an assumption is made that the underlying distribution is Normal (Gaussian). Once this assumption is made, then the extreme values are tested. However, if the underlying distribution is skewed, then what are perfectly reasonable values for the true, skewed, distribution may be deemed as outliers if the Normal assumption is made. This invention uses outlier detection followed by a robust quantile estimator to compute the limits of the Reference Interval. It is important to note that a robust procedure alone (i.e., without outlier detection) is not sufficient. Although robust procedures do resist the effect of outliers, they must retrieve information in that part of the sample where the outliers are most likely to occur (e.g., the upper 2.5%). In other words, if the Clinical Chemists were only interested 50% Reference Intervals, instead of 95%, then outlier detection would not be necessary in most cases.

For this procedure, it is recognized that the underlying population of analytical values from healthy individuals is probably skewed (most often to the right) but, in addition, outliers may exist in the observed sample. This proposed procedure also recognizes that, no matter what the situation, it is difficult to distinguish an extreme “healthy” observation from that of an “unhealthy” observation. Thus, for this invention, a two-stage outlier detection scheme is used that employs the Box-Cox method of data transformation followed by a robust approach to labeling outliers due to Tukey: Exploratory Data Analysis, by J. W. Tukey, Addison-Wesley, Reading: Mass.: 1977, p. 506.

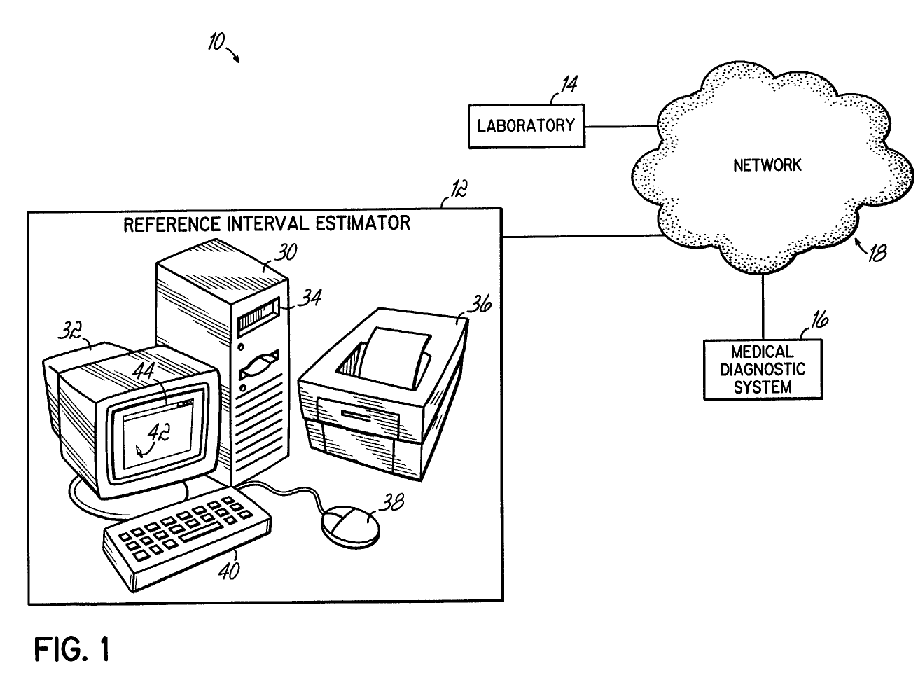

Turning to the Drawings, wherein like numbers denote like parts throughout the several views, FIG. 1 illustrates a computer system 10 consistent with the invention for calculating a robust Reference Interval. Computer system 10 is illustrated as a networked computer system including one or more computers 12-16 (e.g., desktop or PC-based computers, workstations, etc.) interacting with one another through a network 18. Network 18 may represent practically any type of networked interconnection including, but not limited to, local-area, wide-area, wireless, and public networks (e.g., the Internet). Moreover, any number of computers and other devices may be networked through network 18 (e.g., multiple servers). In particular, a user computer 12, depicted as a robust Reference Interval estimator, connects to the network 18 to obtain sample data from a laboratory computer 14, which is also connected to the network 18. Once the user computer 12 has calculated a robust Reference Interval from the sample data, user computer 12 makes the calculations available for clinical use, such as by a medical diagnostic system computer 16.

User computer 12, which may be similar to computers 14, 16, may include a central processing unit (CPU) 30; a number of peripheral components, such as a computer display 32; a storage device 34; a printer 36; and various input devices (e.g., a mouse 38 and keyboard 40), among others. A user may move the mouse 38 to manipulate a cursor 42 and thereby interact with an application program depicted as a window 44 present on the computer display 32.

In general, the routines executed to implement the embodiments of the invention, whether implemented as part of an operating system or a specific application, component, program, object, module, or sequence of instructions, will be referred to herein as “computer programs,” or simply “programs.” The computer programs typically comprise one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms and that the invention applies equally, regardless of the particular type of signal bearing media used to actually carry out the distribution. Examples of signal bearing media include, but are not limited to, recordable type media such as volatile and non-volatile memory devices, floppy and other removable disks, hard disk drives, magnetic tape, optical disks (e.g., CD-ROMs, DVDs, etc.), among others, and transmission type media such as digital and analog communication links.

In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Those skilled in the art will recognize that the exemplary environments illustrated in FIG. 1 are not intended to limit the present invention. Indeed, those skilled in the art will recognize that other alternative hardware and/or software environments may be used without departing from the scope of the invention.

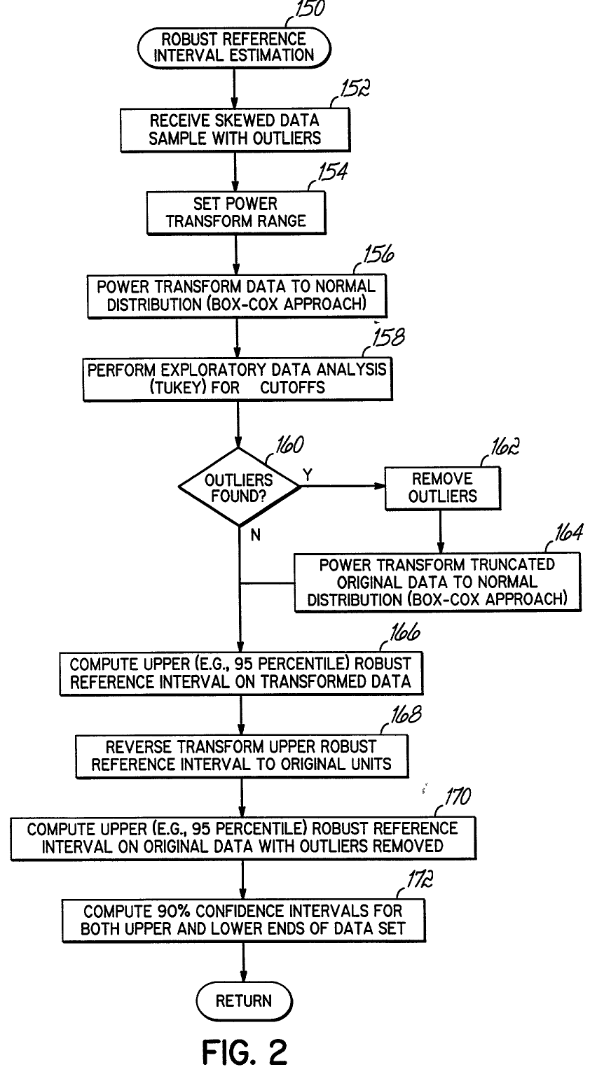

FIG. 2 illustrates a sequence of operations for robust interval estimation, depicted as routine 150. Control begins with receiving a small (e.g., 20+) set of data samples that are typically skewed to the right with suspected outliers (block 152). Then, a range limit is optionally imposed on the power transform (e.g., −1 to 1) (block 154). The range limit prevents an excessively large power transform factor because very extreme values are outside the range of usual interest in a Reference Interval setting (Statistical Bases of Reference Intervals in Laboratory Medicine, by E. K. Harris and J. Boyd, Marcel Dekker, Inc., New York: N.Y.: 1995: p. 361).

Power Transformation

Then, a first-stage analysis is made to transform the set of data samples to a normal distribution using a power transformation (block 156). The need for power transformation, in a parametric setting, arises because the usual assumptions when one analyzes data are that the data conform to a Normal model with constant variance and that the observations are independent. If the first assumption is not met, the data must be transformed to meet the Normal assumption. (If the latter assumption is not met by the data, then a new analysis must be devised, which is not within the scope of this invention.)

An illustrative example of using a power transformation to remove the skew, or lack of normality, from a set of data samples is the Box-Cox method of transformation, which begins with the following transformation equation:

$${y}^{( λ )} = \{ \begin{matrix}( {y}^{λ} - 1 ) / λ ; & λ > 0 \\ ln ( y + c ) ; & λ = 0\end{matrix} \qquad Equation 1.$$

where y is an original observation, y^{(λ)} the “new” observation, and λ a real unknown parameter. It is assumed that, for some λ, the n transformed observations

$${y}^{( λ )} = [ \begin{matrix}{y}_{1}^{( λ )} \\ {y}_{2}^{( λ )} \\ ⋮ \\ {y}_{n}^{( λ )}\end{matrix} ] \qquad Equation 2.$$

are independent and normally distributed with a mean value θ and constant variance σ², i.e., for all \hat{λ},

Eyᵢ^{(λ)}=θ and Var(yᵢ^{(λ)})=σ² Equation 3.

where θ and θ² are parameters associated with the transformed observations. The parameters are estimated by maximum likelihood as follows. First, given λ,

$$\begin{matrix}\hat{θ} ( λ ) = \frac{1}{n} {\sum }_{i = 1}^{n} {y}_{i}^{( λ )} and & Equation 4. \\ {\hat{σ}}^{2} ( λ ) = \frac{1}{n} [ {\sum }_{i = 1}^{n} {( {y}_{i}^{( λ )} )}^{2} - \frac{1}{n} {( {\sum }_{i = 1}^{n} {y}_{i}^{( λ )} )}^{2} ] & Equation 5.\end{matrix}$$

are the estimators of θ and σ², respectively. Second λ is estimated by maximizing the log likelihood function

l(λ)=−n ln \hat{σ}²(λ)/2+ln J(λ:y) Equation 6.

where

$$J ( λ : y ) = {\prod }_{i = 1}^{n} {y}_{i}^{λ - 1} \qquad Equation 7.$$

The maximum likelihood estimator of λ, \hat{λ}, is then substituted into Equation 1, which determines the estimators of the other parameters.

If the computed value of \hat{λ} is less than, say 0.05 in absolute value, then λ is set equal to zero and the transformation y^{(λ)}=ln(y+c) is used. In this case, the likelihood takes on a slightly different form, but the maximum likelihood estimator of c, ĉ, is computed similarly to that of λ, as described in Statistical Bases of Reference Values in Laboratory Medicine, by E. K. Harris and J. Boyd, Marcel Dekker, Inc., New York: N.Y.: 1995: p. 361.

It will be appreciated by one skilled in the art having the benefit of the instant disclosure that other power transformations may be used to normalize the set of data samples.

Thereafter, an outlier cutoff calculation is made (block 158). An illustrative methodology is described in Exploratory Data Analysis, by J. W. Tukey, Addison-Wesley, Reading: Mass.: 1977, p. 506. In particular, the set of data values are ordered, either ascending or descending, by magnitude. The depth of each sample is noted with the end samples having a depth of 1 and each more inward sample having an incremented depth. The median M has the greatest depth:

d(M)=(n+1)/2 Equation 8.

The median splits an ordered set in half. Each half has a hinge H that is the summary value in the middle of each half of samples, about a quarter of the way in from each end of the ordered set. The depth of each hinge H is as follows:

d(H)=([d(M)]+1)/2 Equation 9.

where, the bracket symbols indicate that any fractional value contained within should be dropped. Moreover, the resulting depth of hinge that has a ½ value due to an even number of samples within the hinge is resolved by averaging the two samples with depths ±½ from the calculated depth. Hinges are similar to quartiles, which are defined so that one quarter of the data lies above the upper quartile and one quarter of the data lies below the lower quartile. The main difference being that the hinges are calculated from the depth of the median, with the result that the hinges often lie slightly closer to the median than do the quartiles.

With these calculations made, outlier cutoffs may be calculated based on the hinges and their difference, the H-spread. We define the inner fences as

lower hinge−(1.5×H-spread) Equation 10.

upper hinge+(1.5×H-spread) Equation 11.

Any data value beyond either inner fence is termed “outside”. The outermost data value on each end that is still not beyond the corresponding inner fence is known as an “adjacent value”. Samples that are “outside” are deemed outliers.

Then a determination is made as to whether any transformed data samples are outliers (block 160). Any transformed data points outside of the fences, i.e., either less than the lower fence or greater than the upper fence, will be considered as outliers, and the original data points will be omitted from subsequent Reference Interval however, that a test for Normality (e.g., Anderson-Darling) be conducted on the transformed data to ensure that the transformation did succeed.

One of the most popular methods for transforming data is the family of transformations described by Box and Cox (Box-Cox method): An analysis of transformations, G. E. P. Box and D. R. Cox, Journal of the Royal Statistical Society, 1964; B26: 211-252. This methodology involves finding, through mathematical techniques, a value for λ (and c, if necessary) for the following transformation of the original data, y:

$${y}^{( λ )} = \{ \begin{matrix}( {y}^{λ} - 1 ) / λ ; & λ > 0 \\ ln ( y + c ) ; & λ = 0\end{matrix}$$

where y is an original observation, y^{(λ)} the “new” observation, and λ is a real unknown parameter.

Very often, it is not possible to obtain the suggested number of 120 individuals of a specific group to define a Reference Interval. In some cases, only 20 or 40 individuals in a particular group may be available for study, which is not an ideal sample because of the potential for large errors in the resulting estimates. For example, in one instance, it was virtually impossible to obtain sufficient numbers to determine the Reference Interval for the metabolism of the drug lidocaine into its metabolite methylxylilide because it was difficult to get volunteers who were both healthy and willing to have lidocaine injected into them. In addition, the actual cost for each individual test result was on the order of $100 or more for the test reagents. To use this assay to make life-or-death decisions in liver transplant patients required that reliable decision-making results with a limited number of test specimens be obtained. A more practical problem is to develop appropriate Reference Intervals for a laboratory in a cost-effective manner; that is, with the minimum numbers of samples. The question estimation (block 162) and the truncated set of data samples are power transformed again to a Normal distribution using the Box-Cox method (block 164), as described above for block 156. If no outlier samples are found in block 160, then there is no need to repeat the power transform of the data samples. However, a valuable determination is thus made that a Reference Interval computed from the set of data samples is not affected by outliers.

From a theoretical standpoint, for the standard Normal distribution, the lower and upper quartiles are ±0.6745, respectively, then the IQR=1.349, and the lower and upper fences are −0.6745−1.5×1.349 and 0.6745+1.5×1.349, or ±2.698, respectively. Therefore, theoretically, only Normal values more than 2.698 standard deviations from the mean will labeled as outliers, according to the Tukey approach (Exploratory Data Analysis, by J. W. Tukey, Addison-Wesley, Reading: Mass.: 1977, p. 506). In other words, for a Normally distributed population, the 0.7% most extreme values will be considered outliers. It should be noted at this point that if the (transformed) data are representative of a Normal population, then approximately 0.7% valid values will have to be omitted. For this reason, the level of the Reference Interval must be adjusted upward to maintain the nominal level. For example, to compute a nominal 90% Reference Interval, a 90.634% Reference Interval must be computed if the above outlier detection scheme is used (for a 95% Reference Interval, 95.67% must be used).

It could be argued that the level should be adjusted upward even more because of the estimation of λ (or c) required for the Box-Cox method of transformation. The reasoning would be that the Box-Cox method of transformation may be unsuccessful (the transformed data may not appear Normal). It could also be argued that the outlier detection limits are functions of the data themselves, such as in Performance of some resistant rules for outlier labeling, by D. C. Hoaglin, B. Iglewicz, and J. W. Tukey, Journal of the American Statistical Association, 1986; 81: 991-999. These arguments would be based on statistical conservatism: where a false negative, in general, is considered more serious than a false positive. However, in the case of Reference Intervals, false negatives (having a “sick” individual declared “healthy”) are, in general, considered more serious than false positives. It is for this reason that this invention takes a middle ground by attempting to maintain the nominal level of the desired Reference Interval, while not allowing statistical conservatism to force the Reference Interval to be unusually wide. It should be noted that the IFCC and NCCLS do not recommend any adjustment to the nominal rate of the Reference Interval following outlier detection.

From now on, these remaining untransformed data points (i.e., with outliers removed) will be referred to as simply as the sample. (In practice, these outliers would be studied further in order to ascertain the reason for unusual behavior.) From the sample, two robust Reference Intervals will be computed: one based on a transformation of the sample (blocks 166, 168), and one based on the raw data, i.e., untransformed sample (block 170).

Robust Reference Intervals Based on Transformed Data

Given the sample, the data are transformed using the Box-Cox method. (Note: if there were no outliers discovered in the original data, then this second Box-Cox method of transformation is unnecessary.) The robust Reference Interval for symmetric populations is computed on the transformed data. This method of deriving robust Reference Intervals (or, equivalently, prediction intervals) is described by A biweight prediction interval for random samples, Paul S. Horn, Journal of the American Statistical Association, 1988; 83: 249-56, and “A robust approach to reference interval estimation and evaluation,” by Paul S. Horn, A. J. Pesce, and B. E. Copeland, Clinical Chemistry, 1998, 44: 622-631. Once the two endpoints defining the Reference Interval are derived, they are back-transformed to the original scale.

The robust prediction interval mimics the traditional prediction interval based on Normal theory. A prediction interval tries to predict the value of the next (unobserved) observation, thus it essentially provides estimates of appropriate percentiles. The traditional (1−α)100% prediction interval is as follows:

\overline{x}±t_{α/2}·(s²+s²/n)^{½}

where \overline{x} is the sample mean, t_{α/2} is the upper α/2 percentile from a Student's t-distribution with n−1 degrees of freedom, s² is the sample variance, and n is the sample size. Note that there are two sources of variability: s² is an estimate of the variability in the predicted observation, and s²/n is the variability in the sample mean. The robust (1−α)100% prediction interval is as follows:

T_{bi}(c₁)±t_{α/2}·(s²bi(c₂)+s²T(c₁))^{½}

where T_{bi}(c₁) is a robust estimator of the center of symmetry based on the bi-square weighting function with tuning constant c₁ (set equal to 3.7 in this application), S²_{T}(C₁) is an estimate of the variability of T_{bi}(c₁), and s²_{bi}(c₂) is an estimate of the variability in the predicted observation (for details, see A biweight approach to the one-sample problem, K. Kafadar, Journal of the American Statistical Association, 1982; 77: 416-424). The tuning constant c₂ is a function of a. For example, for a 90% interval, the tuning constant c₂ is approximately equal to 30 and, for a 95% interval tuning constant, c₂ is approximately 200.

Robust Reference Intervals Based on Untransformed Data

With reference to block 170, this robust prediction (reference) interval was designed specifically for estimating upper percentiles from skewed data (which are most common in Clinical Chemistry). The lower endpoint of the interval uses either the traditional nonparametric estimator (if there are enough observations), or a smoothed nonparametric estimator, due to A new distribution-free quantile estimator, F. E. Harrel and C. E. Davis, Biometrika, 1982; 69: 635-670. To get a robust upper percentile estimate from a skewed population, symmetry is forced on the sample by ignoring all data less than the median and then reflecting the remaining data about the median, to yield a symmetric sample of the same size with the same median. (For example, if the original data were the values 22, 24, 30, 45, 48, then the reflected symmetric sample would be 12, 15, 30, 45, 48.) From this symmetric sample, the upper endpoint of the robust interval for symmetric populations described in equation (2) is computed as described by Robust quantile estimators for skewed populations, Paul S. Horn, Biometrika, 1990; 77: 631-6.

Finally, estimates of the precision of the endpoints of the Reference Intervals will be provided (block 172). These confidence intervals for each endpoint will be derived using standard bootstrapping techniques. This process involves resampling (with replacement) from the original data set (with the outliers, if any, removed, as previously described) and computing new robust Reference Intervals. This process is repeated several hundred times, yielding several hundred lower and upper endpoints of the respective robust method. From these several hundred values of the upper endpoint, for instance, the observed 5th and 95th percentiles are used to form a 90% confidence interval for the upper endpoint of the robust Reference Interval.

As an example, the following 361 values of Lactate Dehydrogenase (LDH) are provided in Table 1:

TABLE 1

| | | | | | | | | | | | | | | |
|---|---|---|---|---|---|---|---|---|---|---|---|---|---|---|
| 211 | 272 | 289 | 309 | 312 | 321 | 324 | 329 | 330 | 335 | 353 | 356 | 357 | 376 | 376 |
| 377 | 381 | 383 | 386 | 387 | 390 | 391 | 391 | 392 | 395 | 397 | 403 | 404 | 406 | 410 |
| 411 | 411 | 416 | 419 | 419 | 423 | 427 | 428 | 431 | 431 | 431 | 432 | 433 | 434 | 435 |
| 435 | 436 | 438 | 441 | 442 | 446 | 447 | 447 | 448 | 448 | 448 | 449 | 449 | 452 | 452 |
| 455 | 457 | 458 | 461 | 461 | 461 | 463 | 466 | 467 | 467 | 469 | 469 | 469 | 469 | 471 |
| 472 | 472 | 478 | 480 | 480 | 481 | 481 | 483 | 488 | 489 | 489 | 490 | 491 | 492 | 492 |
| 493 | 493 | 493 | 493 | 495 | 500 | 500 | 501 | 506 | 509 | 510 | 511 | 512 | 512 | 513 |
| 516 | 517 | 518 | 519 | 519 | 521 | 521 | 523 | 524 | 524 | 524 | 525 | 526 | 527 | 527 |
| 527 | 527 | 528 | 531 | 531 | 532 | 533 | 534 | 536 | 537 | 537 | 538 | 541 | 542 | 544 |
| 547 | 548 | 549 | 549 | 550 | 552 | 552 | 553 | 555 | 555 | 556 | 558 | 560 | 564 | 565 |
| 565 | 565 | 569 | 569 | 572 | 572 | 573 | 573 | 573 | 573 | 575 | 576 | 576 | 581 | 581 |
| 583 | 585 | 586 | 586 | 589 | 589 | 590 | 591 | 591 | 592 | 595 | 597 | 601 | 602 | 603 |
| 604 | 606 | 608 | 609 | 609 | 609 | 611 | 612 | 618 | 618 | 619 | 620 | 621 | 622 | 628 |
| 633 | 635 | 636 | 640 | 642 | 642 | 644 | 646 | 650 | 651 | 653 | 659 | 661 | 663 | 664 |
| 664 | 666 | 667 | 667 | 672 | 672 | 673 | 673 | 674 | 679 | 682 | 684 | 684 | 684 | 685 |
| 687 | 691 | 693 | 694 | 696 | 698 | 698 | 700 | 703 | 704 | 705 | 706 | 708 | 710 | 713 |
| 716 | 716 | 716 | 717 | 717 | 719 | 720 | 723 | 727 | 727 | 729 | 734 | 734 | 735 | 739 |
| 739 | 757 | 758 | 760 | 762 | 766 | 784 | 788 | 792 | 797 | 804 | 813 | 814 | 814 | 817 |
| 819 | 825 | 828 | 830 | 830 | 838 | 838 | 844 | 845 | 853 | 854 | 862 | 864 | 876 | 876 |
| 881 | 891 | 895 | 900 | 907 | 909 | 910 | 916 | 934 | 939 | 941 | 941 | 958 | 964 | 965 |
| 976 | 983 | 988 | 991 | 998 | 1004 | 1019 | 1023 | 1026 | 1042 | 1060 | 1064 | 1069 | 1077 | 1082 |
| 1090 | 1126 | 1130 | 1144 | 1146 | 1156 | 1168 | 1183 | 1188 | 1191 | 1199 | 1202 | 1216 | 1237 | 1237 |
| 1261 | 1286 | 1324 | 1333 | 1347 | 1347 | 1352 | 1368 | 1370 | 1383 | 1385 | 1404 | 1460 | 1491 | 1544 |
| 1679 | 1707 | 1867 | 1918 | 1936 | 2005 | 2327 | 2594 | 2614 | 4062 | 4074 | 4537 | 4596 | 4794 | 13980 |
| 66592 | | | | | | | | | | | | | | |

The outlier detection technique described in this procedure omitted nine data values: the two smallest and the seven largest. (It is noteworthy that Dixon's range test found the same seven upper outliers, but none at the lower end.) After the removal of these outliers, the following 95% Reference Intervals were computed:

TABLE 2

| | Untransformed | | Transformed | |
|---|---|---|---|---|
| | Nonparametric | Robust | Normal Theory | Robust |
| Lower Endpoint | 335 | 342 | 348 | 345 |
| Upper Endpoint | 1707 | 1579 | 1666 | 1689 |

In this case, the robust Reference Interval based on the untransformed data happened to give the smallest upper endpoint. The traditional nonparametric upper endpoint was larger by almost 10%. Note that there is one value in the data set, 1679, that lies between the upper endpoints of the two robust methods. This value could be considered “marginal” since it would be deemed healthy by one robust method and unhealthy by another.

Finally, a bootstrap resampling procedure was run to determine 90% confidence intervals for lower and upper endpoints of the two robust procedures. From the sample of 352 observations, i.e., with the outliers removed, B=1999 samples of size 352 were taken with replacement and the robust Reference Intervals were computed. The sample percentiles from these B=1999 lower and upper endpoints provided the following empirical 90% confidence intervals given in Table 3:

TABLE 3

| 90% Confidence Intervals | Untransformed Robust | Transformed Robust |
|---|---|---|
| Lower Endpoint | (324-371) | (332-358) |
| Upper Endpoint | (1425-1729) | (1507-1895) |

For comparison, 90% confidence intervals for the endpoints of the 95% Reference Intervals derived from the traditional nonparametric and transformed Normal theory methods are provided in Table 2:

TABLE 4

| 90% Confidence | | |
|---|---|---|
| Intervals | Nonparametric | Transformed Normal Theory |
| Lower Endpoint | (321-381) | (337-361) |
| Upper Endpoint | (1383-2005) | (1501-1866) |

It is noteworthy that the untransformed robust method not only gave the smallest estimate of the upper endpoint of the 95% Reference Interval, but had the most (estimated) precision in this case, i.e., its confidence interval was the narrowest. This is important because, for many analytes, such as LDH, large values are indicative of a serious health concern.

As another example, Table 5 shows a set of 35 data samples, a sample size too small for traditional nonparametric techniques. In particular, samples were generated from a half-Cauchy distribution that is very heavy-tailed.

TABLE 5

| | | | | | | |
|---|---|---|---|---|---|---|
| 0.003 | 0.079 | 0.088 | 0.140 | 0.207 | 0.214 | 0.284 |
| 0.301 | 0.302 | 0.335 | 0.374 | 0.395 | 0.445 | 0.447 |
| 0.479 | 0.480 | 0.506 | 0.538 | 0.652 | 0.768 | 0.782 |
| 1.055 | 1.098 | 1.176 | 1.316 | 1.526 | 1.676 | 1.812 |
| 2.142 | 2.190 | 2.731 | 2.808 | 3.072 | 5.944 | 29.922 |

The following are resulting 95% Reference Intervals computed using the inventive method (note that Outlier Detection removed the smallest and largest values):

TABLE 6

| | 95% | | | | |
|---|---|---|---|---|---|
| | Reference | | | | |
| | Intervals | 90% Confidence Intervals for endpoints: | | | |
| Robust | (.09, 4.54) | Lower: | (.08, .16) | Upper: | (2.77, 6.00) |
| Transformed | (.09, 5.89) | Lower: | (.06, .14) | Upper: | (3.44, 10.04) |
| Normal | | | | | |
| Transformed | (.08, 7.36) | Lower: | (.03, .15) | Upper: | (3.51, 13.16) |
| Robust | | | | | |

Please note that if outlier samples were not removed, the Transformed Normal Theory results would be: 95% Reference Interval: (0.01, 8.55), with 90% Confidence Intervals for the endpoints: (0, 0.05) and (4.67, 15.26), respectively.

In use, a set of data samples for an analyte taken from a cohort of individuals is sorted by magnitude from low to high. In particular, it is often the case that the set is too small for conventional nonparametric calculation of a Reference Interval. Moreover, the set is presumed to be skewed from a Normal distribution and to have outliers. In order to compute the Reference Interval, the set is power transformed by the Box-Cox method. Then, Exploratory Data Analysis (Exploratory Data Analysis, by J. W. Tukey, Addison-Wesley, Reading: Mass.: 1977, p. 506) is performed on the transformed set to identify outlier cutoffs. Based on these outlier cutoffs, any outliers from the set are removed and the truncated set is power transformed again and the Reference Interval is calculated.

By virtue of the foregoing, a Reference Interval may be calculated from a small set of data samples, such as 20 samples or more. Thereby, medical decisions may be made regarding the health of an individual without having to undergo the expense and inconvenience of assembling an otherwise large set of data samples to establish a Reference Interval.

While the invention has been described in connection with what is presently considered to be the most practical and preferred embodiments, it is to be understood that the invention is not to be limited to the disclosed embodiments but, on the contrary, is intended to cover various modifications and equivalent arrangements included within the spirit and scope of the appended claims.

The invention in its broader aspects is, therefore, not limited to the specific details, representative apparatus and method, and illustrative examples shown and described. Accordingly, departures may be made from such details without departing from the spirit or scope of the general inventive concept.

Having described the invention, what is claimed is:

1. A method for determining a Reference Interval, comprising:
power transforming a set of data samples;
performing exploratory data analysis on the power transformed set of data samples to identify an outlier cutoff;
truncating the set of data samples by removing outlier data samples that are beyond the outlier cutoff;
power transforming the truncated set of data samples;
computing a Reference Interval based on the power transformed truncated set of data samples; and
reverse power transforming the Reference Interval.

2. The method of claim 1, wherein power transforming a set of data samples includes setting a predetermined limit on a power factor used in the power transformation.

3. The method of claim 1, wherein power transforming a set of data samples further comprises performing a Box-Cox method of transformation.

4. The method of claim 1, further comprising:
computing a Reference Interval based on the truncated set of data samples.

5. An apparatus, comprising:
a memory containing a program configured to power transform a set of data samples, to perform exploratory data analysis on the power transformed set of data samples to identify an outlier cutoff, to truncate the set of data samples by removing outlier data samples that are beyond the outlier cutoff, to power transform the truncated set of data samples, to compute a Reference Interval based on the power transformed truncated set of data samples, and to reverse power transform the Reference Interval; and
computing circuitry coupled to the memory for executing the program.

6. The apparatus of claim 5, wherein the program is configured to power transform the set of data samples by setting a predetermined limit on a power factor used in the power transformation.

7. The apparatus of claim 5, wherein the program is configured to power transform the set of data samples by performing a Box-Cox method of transformation.

8. The apparatus of claim 5, wherein the program is further configured to compute a Reference Interval based on the truncated set of data samples.

9. A program product, comprising:
a program configured to power transform a set of data samples, to perform exploratory data analysis on the power transformed set of data samples to identify an outlier cutoff, to truncate the set of data samples by removing outlier data samples that are beyond the outlier cutoff, to power transform the truncated set of data samples, to compute a Reference Interval based on the power transformed truncated set of data samples, and to reverse power transform the Reference Interval; and
a signal bearing media bearing the program.

10. The program product of claim 9, wherein the signal bearing media is transmission type media.

11. The program product of claim 9, wherein the signal bearing media is recordable media.
